(19) United States
(12) Patent Application Publication
(10) Pub. No.: US 2026/0349616 A1
(43) Pub. Date: Nov. 5, 2026

(54) METHOD AND SYSTEM FOR MANAGING RAID, ELECTRONIC DEVICE AND NON-TRANSITORY READABLE STORAGE MEDIUM

(71) Applicant: SUZHOU METABRAIN INTELLIGENT TECHNOLOGY CO., LTD., Suzhou, Jiangsu (CN)

(72) Inventors: Xingyuan LI, Suzhou, Jiangsu (CN); Huajin SUN, Suzhou, Jiangsu (CN); Jiang WANG, Suzhou, Jiangsu (CN); Shuqing LI, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 19/124,600

(22) PCT Filed: Mar. 30, 2023
(86) PCT No.: PCT/CN2023/085269

§ 371 Date: Apr. 25, 2025

(30) Foreign Application Priority Data
Nov. 11, 2022 (CN) 202211409875.8

(51) Int. Cl. G06F 3/06

(52) U.S. Cl. CPC G06F 3/065; G06F 3/0619; G06F 3/0688

(57) ABSTRACT

A method and system for managing Redundant Array of Independent Disk (RAID), an electronic device and a non-transitory readable storage medium are provided. The method for managing RAID includes: constructing an RAID management command by using an RAID management tool; encapsulating the RAID management command into a Submission Queue Entry (SQE) format; and writing encapsulated RAID management command into an Admin Submission Queue (SQ) of an RAID controller by using a Non-Volatile Memory Express (NVMe) device driver, and sending notification information to the RAID controller via a doorbell register, so that the RAID controller executes the RAID management command in the Admin SQ after receiving the notification information.

### CROSS-REFERENCE TO RELATED APPLICATIONS

The present application is a National Stage Entry under 35 U.S.C. § 371 of PCT International Application No PCT/CN2023/085269 filed on Mar. 30, 2023, which claims the priority of Chinese Patent Application 202211409875.8, filed in the China Patent Office on Nov. 11, 2022, and entitled “Method and System for Managing RAID, Electronic Device and Non-Transitory Readable Storage Medium”, the entire contents of which are herein incorporated by reference.

### TECHNICAL FIELD

Embodiments of the present disclosure relate to the technical field of storage management, and in particular to a method and system for managing RAID, an electronic device, and a non-transitory readable storage medium.

### BACKGROUND

An RAID refers to a redundant array of independent disks, and the RAID combines a plurality of disk devices into one or more storage array groups, so as to improve performance and increase redundancy to protect data. An NVMe (Non-volatile memory express, a storage device specification based on PCIe) specification is a high-speed solid state disk storage device interface specification, which is characterized by high performance, low latency, simple interface and good scalability. Therefore, a good open-source software support is provided on a host-side driver and application software, and the development cost of host-side software may be reduced by using an NVMe interface to implement the RAID controllers. However, the NVMe specification only defines a basic storage device interface, but does not include an RAID-related concept.

### SUMMARY

Embodiments of the present disclosure provide a method for managing RAID, which is applied to a host connected with an RAID controller, wherein the host includes an RAID management tool based on an NVMe interface, and an NVMe device driver, the RAID controller is connected with an RAID, and the method for managing RAID includes:
constructing an RAID management command by using the RAID management tool, and encapsulating the RAID management command into an SQE format; and
writing encapsulated RAID management command into an Admin SQ of the RAID controller by using the NVMe device driver, and sending notification information to the RAID controller via a doorbell register, so that the RAID controller executes the RAID management command in the Admin SQ after receiving the notification information.

In some embodiments of the present disclosure, the method further includes:
in response to that the NVMe device driver receives an interrupt notification, reading a command completion queue entry in an Admin CQ, and returning the command completion queue entry to the RAID management tool,
wherein the command completion queue entry is constructed by the RAID controller according to an execution result of the RAID management command.

In some embodiments of the present disclosure, constructing the RAID management command by using the RAID management tool includes:
constructing, by using the RAID management tool, the RAID management command including a command operation code, a command parameter and a data pointer,
wherein the RAID controller is configured to store data to be returned, which is obtained after the RAID management command is executed, in an address space to which data pointer points.

Embodiments of the present disclosure further provide a method for managing RAID, which is applied to an RAID controller connected with a host, wherein the host includes an RAID management tool based on an NVMe interface, and an NVMe device driver, the RAID controller is connected with an RAID, and the method for managing RAID includes:
after receiving notification information sent by a doorbell register, reading, from an Admin SQ, an RAID management command issued by the host, wherein a process of the host issuing the RAID management command includes: constructing the RAID management command by using the RAID management tool, and encapsulating the RAID management command into an SQE format; and writing encapsulated RAID management command into the Admin SQ of the RAID controller by using the NVMe device driver, and sending the notification information to the RAID controller via the doorbell register; and
executing an operation corresponding to the RAID management command.

In some embodiments of the present disclosure, after executing the operation corresponding to the RAID management command on the RAID, the method further includes:
constructing a command completion queue entry according to an execution result of the RAID management command; and
writing the command completion queue entry into the Admin CQ of the host, and sending an interrupt notification to the NVMe device driver, so that the NVMe device driver reads the command completion queue entry in the Admin CQ and returns the command completion queue entry to the RAID management tool.

In some embodiments of the present disclosure, in response to that the RAID management command is an RAID controller discovery command, executing the operation corresponding to the RAID management command includes:
parsing the RAID controller discovery command to obtain a first data pointer; and
summarizing characteristic data of the RAID controller, and returning the characteristic data of the RAID controller to an address space to which the first data pointer points,
wherein the characteristic data of the RAID controller includes any one or a combination of any more of a ready state, a firmware version number, a serial number, a supported RAID level list, a physical disk number list supported by each RAID level, a supported RAID data arrangement mode list, a supported RAID level migration type list, a supported physical disk type list, supported data Cache characteristics, a supported power down protection feature, and state of a standby power supply; and the data Cache characteristics include a Cache capacity and/or a Cache policy type.

In some embodiments of the present disclosure, in response to that the RAID management command is a physical disk discovery command, executing the operation corresponding to the RAID management command includes:
parsing the physical disk discovery command to obtain a second data pointer;
acquiring a physical disk list data structure of all physical disks in the RAID, and returning the physical disk list data structure to an address space to which the second data pointer points, wherein the physical disk list data structure includes an identifier of each physical disk;
or, determining a target physical disk corresponding to the physical disk discovery command, and returning physical disk information of the target physical disk to the address space to which the second data pointer points, wherein the physical disk information includes any one or a combination of any more of the identifier of the target physical disk, state of the physical disk, type of the physical disk, size of a logical block supported by the physical disk, capacity of the physical disk, and topological information of the physical disk.

In some embodiments of the present disclosure, in response to that the RAID management command is an RAID group discovery command, executing the operation corresponding to the RAID management command includes:
parsing the raid group discovery command to obtain a third data pointer;
acquiring an RAID group list data structure of all RAID groups in the RAID, and returning the RAID group list data structure to an address space to which the third data pointer points, wherein the RAID group list data structure includes an identifier of each RAID group;
or, determining a target RAID group corresponding to the RAID group discovery command, and returning RAID group information of the target RAID group to the address space to which the third data pointer points, wherein the RAID group information includes any one or a combination of any more of the identifier of the target RAID group, the state of the RAID group, the level of the RAID group, the size of a logical block supported by the RAID group, the capacity of the RAID group, Cache attributes of the RAID group, the state and progress of a background task of the RAID group, and a physical disk list and state of the RAID group.

In some embodiments of the present disclosure, in response to that the RAID management command is a logical volume discovery command, executing the operation corresponding to the RAID management command includes:
parsing the logical volume discovery command to obtain a fourth data pointer and an identifier of an RAID group to be queried; and
according to the identifier of the RAID group to be queried, returning logical volume information of the RAID group to be queried to an address space to which the fourth data pointer points,
wherein the logical volume information includes any one or a combination of any more of an identifier of a logical volume, the capacity of the logical volume, the state of the logical volume, and an identifier of an NVM namespace bound to the logical volume.

In some embodiments of the present disclosure, in response to that the RAID management command is a logical volume binding command, executing the operation corresponding to the RAID management command includes:
parsing the logical volume binding command to obtain an ID of a logical volume to be bound;
determining a first namespace which is idle, and sending a namespace binding notification to the host, so that the host sends a to-be-bound namespace query command, wherein the to-be-bound namespace query command is used for acquiring an identifier of a namespace to be bound; and
in response to receiving the to-be-bound namespace query command, uploading an identifier of the first namespace to the host, so that the host binds the identifier of the first namespace to the ID of the logical volume to be bound.

In some embodiments of the present disclosure, in response to that the RAID management command is a logical volume unbinding command, executing the operation corresponding to the RAID management command includes:
parsing the logical volume unbinding command to obtain an ID of a logical volume to be unbound;
judging whether all ongoing IO operations on a logical volume corresponding to the ID of the logical volume to be unbound have been executed;
in a case where it is judged that all ongoing IO operations on the logical volume corresponding to the ID of the logical volume to be unbound have been executed, sending a namespace unbinding notification to the host, so that the host sends a to-be-unbound namespace query command, wherein the to-be-unbound namespace query command is used for acquiring an identifier of a namespace to be unbound; and
in response to receiving the to-be-unbound namespace query command, uploading an identifier of a second namespace to the host, so that the host unbinds the identifier of the second namespace and the ID of the logical volume to be unbound, wherein the second namespace is a namespace bound to the logical volume corresponding to the ID of the logical volume to be unbound.

In some embodiments of the present disclosure, in response to that the RAID management command is a namespace IO read-write command, executing the operation corresponding to the RAID management command includes:
determining a target namespace corresponding to the namespace IO read-write command, and determining a target logical volume bound to the target namespace;
converting an operation parameter of the target namespace in the namespace IO read-write command into an operation parameter of the target logical volume, wherein the operation parameter includes addresses of logical blocks and number of logical blocks; and
executing an IO read-write operation on the target logical volume according to the operation parameter of the target logical volume.

In some embodiments of the present disclosure, in response to that the RAID management command is an asynchronous event reporting command, executing the operation corresponding to the RAID management command includes:
detecting an RAID management event, and determining an event type corresponding to the RAID management event; and
reporting, to the host, a state code corresponding to the event type, so that the host acquires related data of the RAID management event from the RAID controller.

In some embodiments of the present disclosure, the RAID management command includes a discovery class command, a disk management class command, and a task management class command.

In some embodiments of the present disclosure, the discovery class command includes RAID controller discovery command, physical disk discovery command, RAID group discovery command, and logical volume discovery command; the disk management class command includes an RAID group creation and deletion command, a logical volume creation and deletion command, and a command for binding and unbinding a logical volume and a namespace; and the task management class command includes a start and stop command of a background task, and a parameter configuration command.

In some embodiments of the present disclosure, the Admin CQ is used for an NVMe controller to report command completion to the host, each command completion queue entry in the Admin CQ corresponds to a command completion data structure reported by one NVMe controller.

Embodiments of the present disclosure further provide a system for managing RAID, which is applied to a host connected with an RAID controller, wherein the host includes an RAID management tool based on an NVMe interface, and an NVMe device driver, the RAID controller is connected with an RAID, and the system for managing RAID includes:
a command construction component, configured to construct an RAID management command by using the RAID management tool, and encapsulate the RAID management command into an SQE format; and
a command issuing component, configured to write encapsulated RAID management command into an Admin SQ of the RAID controller by using the NVMe device driver, and send notification information to the RAID controller via a doorbell register, so that the RAID controller executes the RAID management command in the Admin SQ after receiving the notification information.

Embodiments of the present disclosure further provide a system for managing RAID, which is applied to an RAID controller connected with a host, wherein the host includes an RAID management tool based on an NVMe interface, and an NVMe device driver, the RAID controller is connected with an RAID, and the system for managing RAID includes:
a command reading component, configured to: after receiving notification information sent by a doorbell register, read, from an Admin SQ, an RAID management command issued by the host, wherein a process of the host issuing the RAID management command includes: constructing the RAID management command by using the RAID management tool, and encapsulating the RAID management command into an SQE format; and writing encapsulated RAID management command into the Admin SQ of the RAID controller by using the NVMe device driver, and sending the notification information to the RAID controller via the doorbell register; and
a command execution component, configured to execute an operation corresponding to the RAID management command.

Embodiments of the present disclosure further provide a non-transitory readable storage medium, storing a computer program thereon, wherein the computer program, when executed, implements the steps executed by the above method for managing RAID.

Embodiments of the present disclosure further provide an electronic device, including a memory and a processor, wherein a computer program is stored in the memory, and the processor, when calling the computer program in the memory, implements the steps executed by the above method for managing RAID.

### BRIEF DESCRIPTION OF THE DRAWINGS

To illustrate embodiments of the present disclosure more clearly, a brief introduction on the drawings to be used in the embodiments will be given below. Apparently, the drawings in the description below are merely some embodiments of the present disclosure, based on which other drawings may also be obtained by those ordinary skilled in the art without any creative effort.

FIG. 1 is a flowchart of a method for managing RAID provided in some embodiments of the present disclosure;

FIG. 2 is a schematic structural diagram of an RAID controller based on an NVMe host interface provided in some embodiments of the present disclosure;

FIG. 3 is a flowchart of another method for managing RAID provided in some embodiments of the present disclosure;

FIG. 4 is an operation flowchart of an RAID management command provided in some embodiments of the present disclosure;

FIG. 5 is a structural diagram of an RAID management command SQE provided in some embodiments of the present disclosure;

FIG. 6 is a structural diagram of an RAID management command CQE provided in some embodiments of the present disclosure;

FIG. 7 is a structural diagram of characteristic data of an RAID controller provided in some embodiments of the present disclosure;

FIG. 8 is a diagram of a physical disk data list structure provided in some embodiments of the present disclosure;

FIG. 9 is a schematic diagram of a relationship among a physical disk, an RAID group and a logical volume provided in some embodiments of the present disclosure;

FIG. 10 is a diagram of an RAID group list data structure provided in some embodiments of the present disclosure;

FIG. 11 is a flowchart of binding a logical volume and a namespace provided in some embodiments of the present disclosure;

FIG. 12 is a flowchart of unbinding a logical volume and a namespace provided in some embodiments of the present disclosure;

FIG. 13 is a flowchart of converting a Namespace IO operation into a logical volume IO operation provided in some embodiments of the present disclosure;

FIG. 14 is an active reporting flowchart of an RAID event provided in some embodiments of the present disclosure; and

FIG. 15 is a schematic structural diagram of a system for managing RAID provided in some embodiments of the present disclosure.

### DETAILED DESCRIPTION OF THE EMBODIMENTS

In order to make the objectives, technical solutions and advantages of the embodiments of the present disclosure clearer, a clear and complete description of technical solutions in the embodiments of the present disclosure will be given below, in combination with the drawings in the embodiments of the present disclosure. Apparently, the embodiments described below are merely a part, but not all, of the embodiments of the present disclosure. All of other embodiments, obtained by those ordinary skilled in the art based on the embodiments in the present disclosure without any creative effort, fall into the protection scope of the embodiments of the present disclosure.

A traditional RAID card is implemented as a PCle device on a computer system, is connected to a host via a PCIe bus, and uses an SCSI (Small Computer System Interface) at a command level. However, the SCSI only defines an application layer, that is, the interaction mode of commands, and does not define protocols on a host interface layer in detail, and this part of content is left to RAID device manufacturers for definition and implementation. Due to the existence of private host interfaces and management commands, RAID controllers implemented by the manufacturers are not compatible with each other in terms of host drivers and management tools. In addition to providing basic RAID services, RAID controller manufacturers also need to invest effort in defining host interfaces, host drivers, RAID management tools, and other implementations, which brings a higher development cost and a longer development cycle to the development of an entire RAID controller chip. An NVMe (Non-volatile memory express, a storage device specification based on PCIe) specification is a high-speed solid state disk storage device interface specification, which is characterized by high performance, low latency, simple interface and good scalability. Therefore, a good open-source software support is provided on a host-side driver and application software, and the development cost of host-side software may be reduced by using an NVMe interface to implement the RAID controllers. However, the NVMe specification only defines a basic storage device interface, but does not include an RAID-related concept. Therefore, how to implement RAID management on an NVMe interface is a technical problem to be solved by those skilled in the art at present.

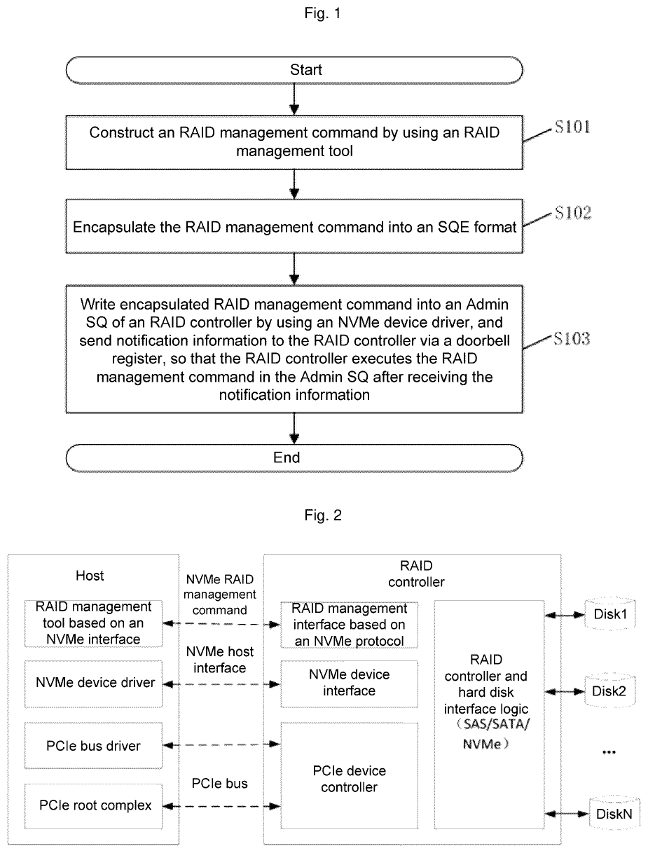

Referring to FIG. 1, FIG. 1 is a flowchart of a method for managing RAID provided in some embodiments of the present disclosure, the management method may be applied to a host connected with an RAID controller, the RAID controller is connected with an RAID, and detailed steps of RAID management may include:
S101: constructing an RAID management command by using an RAID management tool.

Referring to FIG. 2, FIG. 2 is a schematic structural diagram of an RAID controller based on an NVMe host interface provided in some embodiments of the present disclosure, the host includes an RAID management tool based on an NVMe interface, an NVMe device driver, a PCIe (Peripheral Component Interconnect Express) bus driver, and a PCIe root complex; the RAID controller includes a management interface based on an NVMe protocol, an NVMe device interface, a PCIe Endpoint (PCIe device controller), and RAID controller and hardware interface logic (SAS/SATA/NVMe); and a Disk 1, a Disk 2, . . . , a Disk N in FIG. 2 form an RAID. The host may send an NVMe RAID management command to the RAID controller via the NVMe host interface, and the host is connected with the RAID controller via a PCIe bus.

In some embodiments of the present embodiment, an interface defined by an NVMe standard is used between the RAID controller and the host, and a host side loads a standard NVMe driver. A standard command defined by NVMe between the RAID controller and the host completes basic operations of a storage device, including operations such as device discovery and IO transmission.

Prior to the present step, there may also be an operation of receiving a user operation request, and then the RAID management command corresponding to the user operation request is constructed by using the RAID management tool. In some embodiments of the present disclosure, the present step may include: constructing, by using the RAID management tool, the RAID management command including a command operation code, a command parameter and a data pointer, wherein the RAID controller may store data to be returned, which is obtained after the RAID management command is executed, in an address space to which the data pointer points, and the RAID controller may also execute an operation corresponding to the RAID management command according to the command operation code and the command parameter.
S102: encapsulating the RAID management command into an SQE format,

wherein after the RAID management command is constructed, the RAID management command may also be encapsulated into a command of the SQE format by using the RAID management tool. The SQE (Submission Queue Entry) refers to a command submission queue entry, and each command submission queue entry corresponds to the NVMe of one host.
S103: writing encapsulated RAID management command into an Admin SQ of the RAID controller by using the NVMe device driver, and sending notification information to the RAID controller via a doorbell register, so that the RAID controller executes the RAID management command in the Admin SQ after receiving the notification information.

The RAID management tool may transmit the encapsulated RAID management command to the NVMe device driver, and write the encapsulated RAID management command into the Admin SQ of the RAID controller by using the NVMe device driver. SQ (Submission Queue) refers to a command submission queue. The Admin SQ is a queue defined by the NVMe standard, and is used for the host to submit a command to an NVMe controller.

After writing the RAID management command into the Admin SQ, the notification information may also be sent to the RAID controller by writing the doorbell register, and after receiving the notification information, the RAID controller may read the Admin SQ to the local and execute the RAID management command in the Admin SQ. The Admin SQ may be a queue inside the host.

The present embodiment provides a host connected with an RAID controller, wherein the host includes an RAID management tool based on an NVMe interface, and an NVMe device driver, and when a host device needs to manage an RAID connected with the RAID controller, an RAID management command may be constructed by using an RAID management tool, and the RAID management command is encapsulated. The NVMe device driver may write, into an Admin SQ of the RAID controller, the RAID management command encapsulated by the RAID management tool. The RAID controller may read and execute the RAID management command in the Admin SQ. In the above solution, an interface defined by an NVMe standard is used between the RAID controller and the host, and a host side loads an NVMe driver. A command defined by the NVMe between the RAID controller and the host completes a management operation of an RAID. The present solution may implement RAID management on the NVMe interface.

In some embodiments of the present disclosure, in response to that the NVMe device driver receives an interrupt notification, a command completion queue entry in an Admin CQ is read, and the command completion queue entry is returned to the RAID management tool, wherein the command completion queue entry is constructed by the RAID controller according to an execution result of the RAID management command.

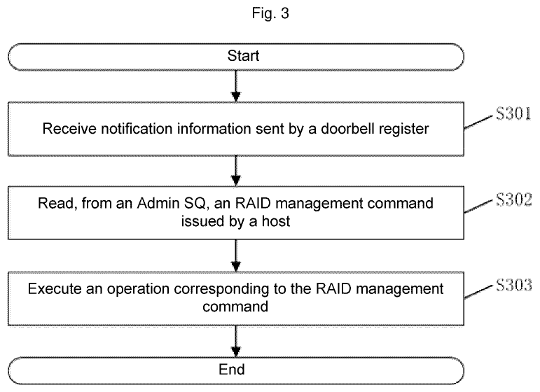

Referring to FIG. 3, FIG. 3 is a flowchart of another method for managing RAID provided in some embodiments of the present disclosure, the method for managing RAID is applied to an RAID controller connected with a host, the host includes an RAID management tool based on an NVMe interface, and an NVMe device driver, the RAID controller is connected with an RAID, and the method for managing RAID may include the following steps:
S301: receiving notification information sent by a doorbell register;
S302: reading, from an admin SQ, an RAID management command issued by the host,

wherein a process of the host issuing the RAID management command includes: constructing the RAID management command by using the RAID management tool, and encapsulating the RAID management command into an SQE format; and writing encapsulated RAID management command into the Admin SQ of the RAID controller by using the NVMe device driver, and sending the notification information to the RAID controller via the doorbell register; and
S303: executing an operation corresponding to the RAID management command.

The RAID management command may include a discovery class command, a disk management class command, and a task management class command; the discovery class command includes an RAID controller discovery command, a physical disk discovery command, an RAID group discovery command, and a logical volume discovery command; the disk management class command includes an RAID group creation and deletion command, a logical volume creation and deletion command, and a command for binding and unbinding a logical volume and a namespace; and the task management class command includes a command of start and stop of background tasks such as rebuild, copyback, capacity expansion, consistency check and disk inspection, a parameter configuration command, etc. Namespace refers to a namespace, the namespace is a logical unit of a storage device on an NVMe device, and each namespace is presented as a storage device to the host, which is similar to a LUN of an SCSI device.

The present embodiment provides an RAID controller connected with a host, wherein the host includes an RAID management tool based on an NVMe interface, and an NVMe device driver, and when a host device needs to manage an RAID connected with the RAID controller, an RAID management command may be constructed by using an RAID management tool, and the RAID management command is encapsulated. The NVMe device driver may write, into an Admin SQ of the RAID controller, the RAID management command encapsulated by the RAID management tool. The RAID controller may read and execute the RAID management command in the Admin SQ. In the above solution, an interface defined by an NVMe standard is used between the RAID controller and the host, and a host side loads an NVMe driver. A command defined by the NVMe between the RAID controller and the host completes a management operation of an RAID. The present solution may implement RAID management on the NVMe interface.

In some embodiments of the present disclosure, after the operation corresponding to the RAID management command is executed on the RAID, a command completion queue entry may also be constructed according to an execution result of the RAID management command; the command completion queue entry is written into an Admin CQ of the host, and an interrupt notification is sent to the NVMe device driver, so that an NVMe device the command completion queue entry in the Admin CQ and returns the command completion queue entry to the RAID management tool. CQ (Completion Queue, command completion queue) is a queue defined by a NVMe standard that is used for the NVMe controller to report command completion to the host; and each CQE (Completion Queue Entry, command completion queue entry) corresponds to a command completion data structure reported by one NVMe controller. After each command issued by the NVMe controller to the host is completed, the CQE is reported in the CQ.

In some embodiments of the present disclosure, in response to that the RAID management command is an RAID controller discovery command, the process of the RAID controller executing the RAID controller discovery command includes: parsing the RAID controller discovery command to obtain a first data pointer; and summarizing characteristic data of the RAID controller, and returning the characteristic data of the RAID controller to an address space to which the first data pointer points.

The characteristic data of the RAID controller includes any one or a combination of any more of a ready state, a firmware version number, a serial number, a supported RAID level list, a physical disk number list supported by each RAID level, a supported RAID data arrangement mode list, a supported RAID level migration type list, a supported physical disk type list, supported data Cache characteristics, a supported power down protection feature, and state of a standby power supply; and the data Cache characteristics include a Cache capacity and/or a Cache policy type.

In some embodiments of the present disclosure, in response to that the RAID management command is a physical disk discovery command, the process of executing the physical disk discovery command includes: parsing the physical disk discovery command to obtain a second data pointer; acquiring a physical disk list data structure of all physical disks in the RAID, and returning the physical disk list data structure to an address space to which the second data pointer points, wherein the physical disk list data structure includes an identifier of each physical disk; or, determining a target physical disk corresponding to the physical disk discovery command, and returning physical disk information of the target physical disk to the address space to which the second data pointer points, wherein the physical disk information includes any one or a combination of any more of the identifier of the target physical disk, state of the physical disk, type of the physical disk, size of a logical block supported by the physical disk, capacity of the physical disk, and topological information of the physical disk.

In some embodiments of the present disclosure, in response to that the RAID management command is an RAID group discovery command, the process of executing the RAID group discovery command includes: parsing the RAID group discovery command to obtain a third data pointer; acquiring an RAID group list data structure of all RAID groups in the RAID, and returning the RAID group list data structure to an address space to which the third data pointer points, wherein the RAID group list data structure includes an identifier of each RAID group; or, determining a target RAID group corresponding to the RAID group discovery command, and returning RAID group information of the target RAID group to the address space to which the third data pointer points, wherein the RAID group information includes any one or a combination of any more of the identifier of the target RAID group, the state of the RAID group, the level of the RAID group, the size of a logical block supported by the RAID group, the capacity of the RAID group, Cache attributes of the RAID group, the state and progress of a background task of the RAID group, and a physical disk list and state of the RAID group.

In some embodiments of the present disclosure, in response to that the RAID management command is a logical volume discovery command, the process of executing the logical volume discovery command includes: parsing the logical volume discovery command to obtain a fourth data pointer and an identifier of an RAID group to be queried; and according to the identifier of the RAID group to be queried, returning logical volume information of the RAID group to be queried to an address space to which the fourth data pointer points, wherein the logical volume information includes any one or a combination of any more of an identifier of a logical volume, the capacity of the logical volume, the state of the logical volume, and an identifier of an NVM namespace bound to the logical volume.

In some embodiments of the present disclosure, in response to that the RAID management command is a logical volume binding command, the process of executing the logical volume binding command includes: parsing the logical volume binding command to obtain an ID of a logical volume to be bound; determining a first namespace which is idle, and sending a namespace binding notification to the host, so that the host sends a to-be-bound namespace query command, wherein the to-be-bound namespace query command is used for acquiring an identifier of a namespace to be bound; and in response to receiving the to-be-bound namespace query command, uploading an identifier of the first namespace to the host, so that the host binds the identifier of the first namespace to the ID of the logical volume to be bound. The first namespace which is idle refers to a namespace that is not bound to a logical volume.

In some embodiments of the present disclosure, in response to that the RAID management command is a logical volume unbinding command, the process of executing the logical volume unbinding command includes: parsing the logical volume unbinding command to obtain an ID of a logical volume to be unbound; judging whether all ongoing IO operations on a logical volume corresponding to the ID of the logical volume to be unbound have been executed; in a case where it is judged that all ongoing IO operations on the logical volume corresponding to the ID of the logical volume to be unbound have been executed, sending a namespace unbinding notification to the host, so that the host sends a to-be-unbound namespace query command, wherein the to-be-unbound namespace query command is used for acquiring an identifier of a namespace to be unbound; and in response to receiving the to-be-unbound namespace query command, uploading an identifier of a second namespace to the host, so that the host unbinds the identifier of the second namespace and the ID of the logical volume to be unbound, wherein the second namespace is a namespace bound to the logical volume corresponding to the ID of the logical volume to be unbound.

In some embodiments of the present disclosure, in response to that the RAID management command is a namespace IO read-write command, the process of executing the namespace IO read-write command includes: determining a target namespace corresponding to the namespace IO read-write command, and determining a target logical volume bound to the target namespace; converting an operation parameter of the target namespace in the namespace IO read-write command into an operation parameter of the target logical volume, wherein the operation parameter includes addresses of logical blocks and number of logical blocks; and executing an IO read-write operation on the target logical volume according to the operation parameter of the target logical volume.

In some embodiments of the present disclosure, in response to that the RAID management command is an asynchronous event reporting command, the process of executing the asynchronous event reporting command includes: detecting an RAID management event, and determining an event type corresponding to the RAID management event; and reporting, to the host, a state code corresponding to the event type, so that the host acquires related data of the RAID management event from the RAID controller. The related data is detailed data of the RAID management event, for example, an occurrence event, an occurrence position, and the like.

The flows described in the above embodiments are described below by embodiments in actual applications.

When a conventional RAID card is connected to a host in the art, on an RAID controller side, a manufacturer self-defines that a host interface is used for encapsulating an upper-layer SCSI command and a response packet, so as to transmit same on a PCIe bus; and the manufacturer further self-defines that an RAID management interface is used for transmitting an RAID management command and a response. On the host, it is necessary for the manufacturer to self-define an RAID controller driver and an RAID management tool. The RAID controller driver is used for detecting, initializing and configuring an RAID controller, providing an IO interface of an RAID storage device for the host, and providing an operation interface for an RAID management tool. The manufacturer self-defines that the RAID management tool is used for exchanging an RAID management related command with the RAID controller. Due to the existence of these private host interfaces and management commands, the RAID controllers implemented by various manufacturers are not compatible with each other in terms of host drivers and management tools. In addition to providing basic RAID services, RAID controller manufacturers also need to invest effort in defining host interfaces, host drivers, RAID management tools, and other implementations, which brings a higher development cost and a longer development cycle to the development of an entire RAID controller chip.

In order to solve the above technical problems, embodiments of the present disclosure provide an RAID management interface and an RAID management solution. The present embodiment provides a method for following the definition of an NVMe standard to send an RAID management command from a host to an RAID controller and return a command execution result to the host after the RAID controller processes the command. The present embodiment provides an RAID controller discovery method based on an NVMe interface. By means of the method, the host may acquire that an NVMe device is an RAID controller, and discover RAID functional characteristics supported by the RAID controller; discover information of a physical disk connected under the RAID controller; and discover information of an RAID group formed by physical disks under the RAID controller, and discover information of a logical storage volume divided on the RAID group. In some embodiments provide, after the RAID group is formed by the physical disks managed by the RAID controller, a method and flow are provided for mapping a logical storage volume established in the RAID group to a host by means of a Namespace defined by an NVMe protocol. The embodiments further provide a flow of separating and deleting the logical storage volume from the Namespace. In some embodiments of the present disclosure, the method flow of the RAID controller actively reporting the RAID management event to the host via the NVMe host interface includes a physical disk state change, an RAID group state change, and a logical storage volume state change.

In some embodiments of the present disclosure, the RAID management interface is implemented by extending an NVMe interface protocol, and these commands conform to command formats defined by the NVMe standard, and follow queues and completion mechanisms required for issuing an NVMe command. The RAID management tool on the host side sends an RAID management command to the device via an interface provided by the driver, and after receiving the command, the RAID controller processes the command and returns an execution result of the command to the host.

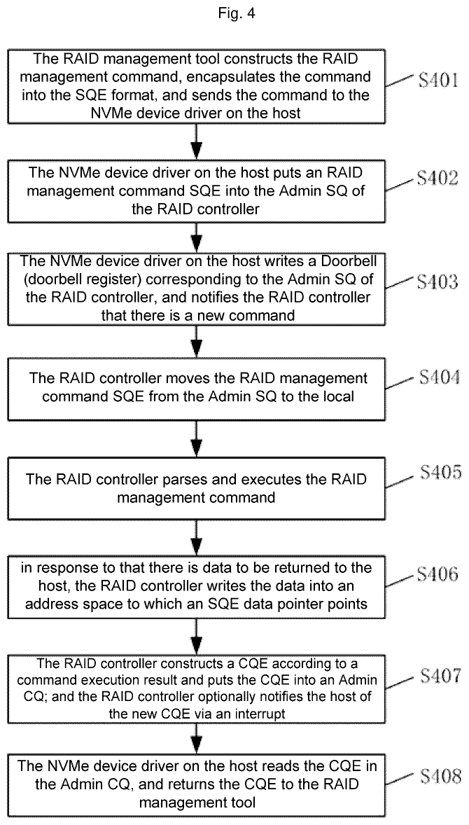

Referring to FIG. 4, FIG. 4 is an operation flowchart of an RAID management command provided in some embodiments of the present disclosure, which may include the following steps:
S401: the RAID management tool constructs the RAID management command, encapsulates the command into the SQE format, and sends the command to the NVMe device driver on the host;
S402: the NVMe device driver on the host puts an RAID management command SQE into the Admin SQ of the RAID controller;
S403: the NVMe device driver on the host writes a Doorbell (doorbell register) corresponding to the Admin SQ of the RAID controller, and notifies the RAID controller that there is a new command,

wherein the DoorBell register is a register on the NVMe controller, and the host writes this register to notify the NVMe controller that a new CQE is submitted to a CQ;
S404: the RAID controller moves the RAID management command SQE from the Admin SQ to the local;
S405: the RAID controller parses and executes the RAID management command;
S406: in response to that there is data to be returned to the host, the RAID controller writes the data into an address space to which an SQE data pointer points;
S407: the RAID controller constructs a CQE according to a command execution result and puts the CQE into an Admin CQ; and the RAID controller optionally notifies the host of the new CQE via an interrupt; and
S408: the NVMe device driver on the host reads the CQE in the Admin CQ, and returns the CQE to the RAID management tool.

The extended RAID management command involved in some embodiments of the present disclosure belongs to an Admin command type defined by the NVMe standard, and the operation code of the command belongs to a manufacture self-defined operation code (Combined Opcode) range specified by the NVMe standard, and the value thereof ranges from C0h to FFh.

In the above operation flow of the RAID management command, the constructed RAID management command SQE (i.e., the RAID management command in the SQE format) includes an RAID management command operation code and an RAID command parameter. The RAID controller executes detailed RAID management command operations according to different operation codes and parameters in the SQE. The data pointer is an option that points to an address space in a host memory, which is allocated by the RAID management tool, and in response to that the RAID controller needs to return data to the host during command execution, the data is written into the address space to which the pointer points.

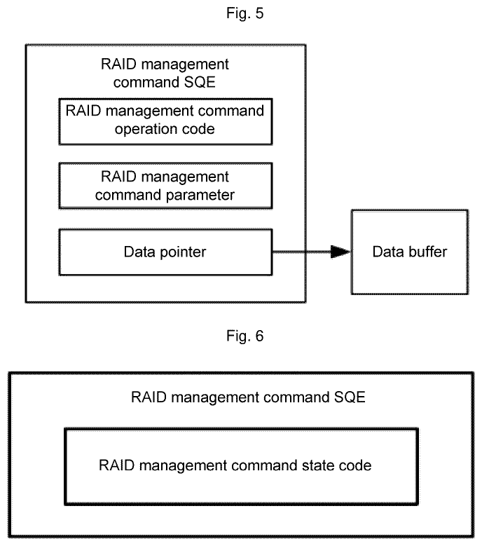

Referring to FIG. 5, FIG. 5 is a structural diagram of an RAID management command SQE provided in some embodiments of the present disclosure. The RAID management command SQE includes an RAID management command operation code, an RAID command parameter, and a data pointer, wherein the data pointer points to a data buffer.

After executing the command, the RAID controller returns the command execution result to the host via a CQE, and the result is returned to the host via a command state code in the CQE. Referring to FIG. 6, FIG. 6 is a structural diagram of an RAID management command CQE provided in some embodiments of the present disclosure. The RAID management command CQE includes an RAID management command state code.

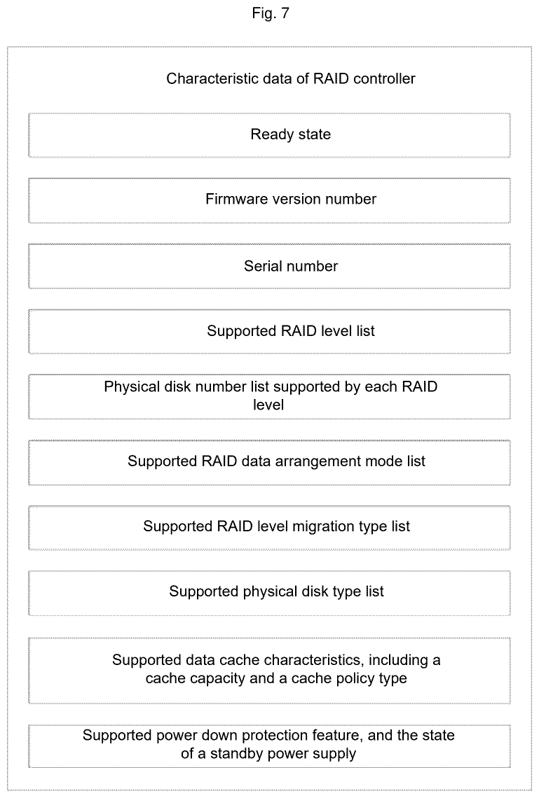

The RAID controller discovery method is a flow and a method for acquiring the information of the RAID controller by the host, and these methods are all completed by implementing an RAID management command flow of method 1. The RAID controller discovery method includes the following four command types:
(1) The processing flow of the RAID controller discovery command: the host acquires characteristic data of the RAID controller via the RAID controller discovery command, and after receiving the command, the RAID controller writes the characteristic data of the RAID controller into the address space to which the data pointer in the SQE points. The content included in the characteristic data of the RAID controller. After acquiring the data, the host may acquire RAID characteristics supported by the RAID controller according to the data. Referring to FIG. 7, FIG. 7 is a structural diagram of characteristic data of an RAID controller provided in some embodiments of the present disclosure, wherein the characteristic data of the RAID controller includes a ready state, a firmware version number, a serial number, a supported RAID level list, a physical disk number list supported by each RAID level, a supported RAID data arrangement mode list, a supported RAID level migration type list, a supported physical disk type list, supported data Cache characteristics (a Cache capacity and/or a Cache policy type), a supported power down protection feature, and the state of a standby power supply.
(2) The processing flow of the physical disk discovery command: as shown in FIG. 2, a series of physical disks, that is, Disk 1 to Disk N, are connected under the RAID controller, these physical disks are managed by the RAID controller, and the host may not directly access these disks. Therefore, a dedicated physical disk discovery command is required to acquire the information of these disks.

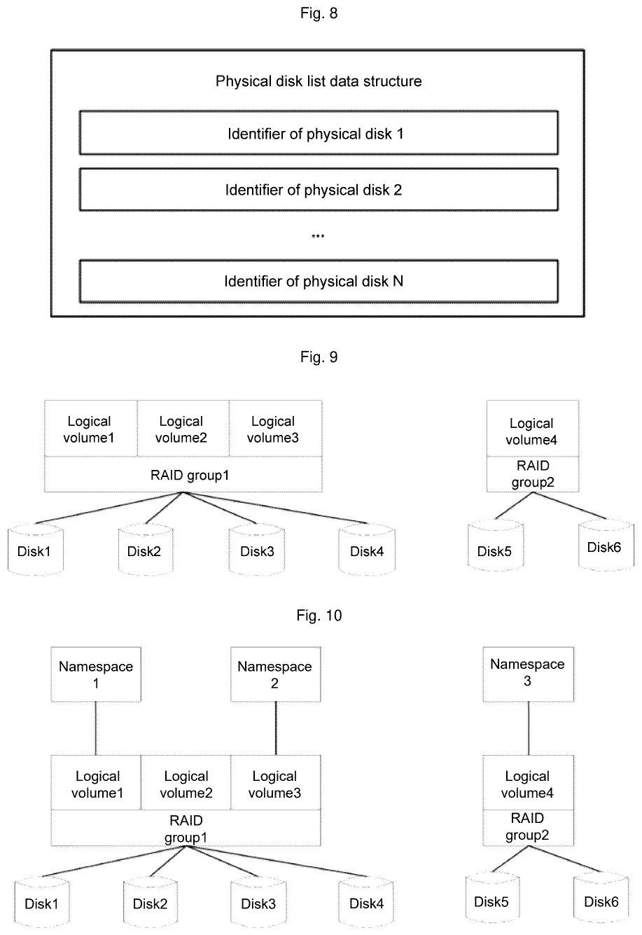

There are two types of physical disk discovery commands, the first type is to acquire a physical disk list, and after receiving the command, the RAID controller writes a physical disk list data structure into the address space to which the data pointer in the SQE points. Referring to FIG. 8, FIG. 8 is a diagram of a physical disk data list structure according to some embodiments of the present disclosure, wherein the physical disk data list structure includes an identifier of a physical disk 1, an identifier of a physical disk 2, . . . , an identifier of a physical disk N.

The second type is to acquire specified physical disk information. The host specifies the identifier of a target physical disk in the RAID management command parameter in the SQE, and after receiving the command, the RAID controller writes a physical disk information data structure into the address space to which the data pointer in the SQE points. The physical disk information includes the following content: the identifier of the physical disk, the state (normal/faulty) of the physical disk, the type (SAS/SATA/NVMe, HDD/SDD) of the physical disk, the size of a logical block supported by the physical disk, the capacity of the physical disk, and topological information (a controller connected with the disk, a bus address, a port number, and the like) of the physical disk.
(3) The processing flow of the RAID group discovery command: referring to FIG. 9, FIG. 9 is a schematic diagram of a relationship among a physical disk, an RAID group and a logical volume provided in some embodiments of the present disclosure. As shown in FIG. 9, there are six physical disks under the RAID controller, a disk 1 to a disk 4 constitute an RAID group 1, and a disk 5 and a disk 6 constitute an RAID group 2. The RAID group discovery command is used for acquiring information of the RAID groups managed by the RAID controller, including the relationship between each RAID group and the physical disks.

There two types of RAID group discovery commands, the first type is to acquire an RAID group list, and after receiving the command, the RAID controller writes an RAID group list data structure into the address space to which the data pointer in the SQE points. Referring to FIG. 10, FIG. 10 is a diagram of an RAID group list data structure according to some embodiments of the present disclosure, wherein the RAID group list data structure includes an identifier of the RAID group 1, an identifier of the RAID group 2, . . . , an identifier of an RAID group N.

The second type is to acquire specified RAID group information. The host specifies the identifier of a target RAID group in the RAID management command parameter in the SQE, and after receiving the command, the RAID controller writes an RAID group information data structure into the address space to which the data pointer in the SQE points. The RAID group information includes the following content: the identifier of the RAID group, the state (normal/degraded/faulty) of the RAID group, the level of the RAID group, the size of a logical block of the RAID group, the capacity of the RAID group, RAID Cache attributes (including Cache quota and capacity), the state and progress (reconstruction/copyback/migration/capacity expansion) of a background task of the RAID group, and the physical disk list and state of the RAID group, wherein each entry in the list includes a physical disk identifier and a physical disk state.
(4) The processing flow of the logical volume discovery command: as shown in FIG. 9, one RAID group may be divided into a plurality of logical volumes. The host acquires logical volume information on a specified RAID group by using the logical volume discovery command. The host specifies the identifier of a target RAID group in the RAID management command parameter in the SQE. After receiving the command, the RAID controller writes a logical volume information data structure on the specific RAID group into the address space to which the data pointer in the SQE points. The logical volume information includes all logical volume lists on the RAID group, and the content of each entry of in the list includes information of the logical volume, including the identifier of the logical volume, the capacity of the logical volume, the state of the logical volume, and an identifier of an NVMe Namespace bound to the logical volume.

Regarding a presentation mode and an IO operation mode of the logical volume on the RAID group to the host, for example, as shown in FIG. 9, there are six physical disks under the RAID controller, the disk 1 (disk 1, or referred to as magnetic disk 1) to the disk 4 constitute the RAID group 1, and the disk 5 and the disk 6 constitute the RAID group 2, wherein the RAID group 1 is divided into three logical volumes, and the RAID group 2 is divided into one logical volume.

Referring to FIG. 10, FIG. 10 is a schematic diagram of a binding relationship between an RIAD logical volume and an NVMe namespace according to some embodiments of the present disclosure. The disk 1 (disk 1, or magnetic disk 1) to the disk 4 (magnetic disk 4) constitute the RAID group 1, and the disk 5 (magnetic disk 5) and the disk 6 (magnetic disk 6) constitute the RAID group 2, and the logical volumes are divided into two states, that is, visible to the host and invisible to the host. The logical volume visible to the host is implemented by binding to the NVMe namespace. The logical volume invisible to the host is not bound to the NVMe namespace. As shown in FIG. 10, a logical volume 1 is bound to a Namespace 1, a logical volume 3 is bound to a Namespace 2, a logical volume 4 is bound to a Namespace 3, and the three logical volumes are visible to the host. A logical volume 2 is not bound to the Namespace, and thus is invisible to the host.

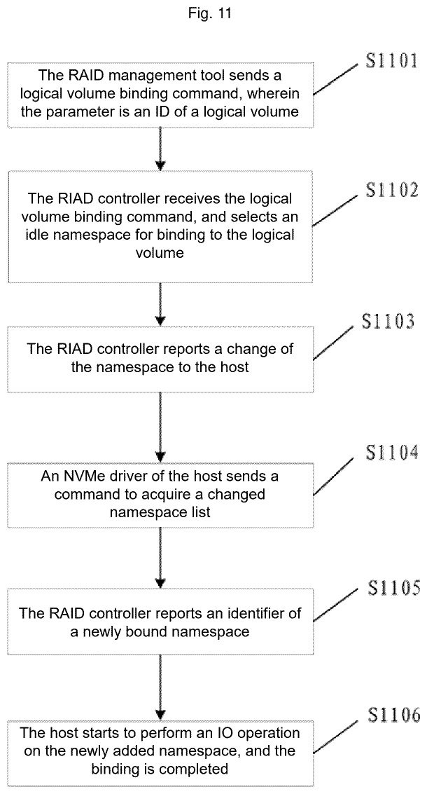

Referring to FIG. 11, FIG. 11 is a flowchart of binding a logical volume and a Namespace provided in some embodiments of the present disclosure, which may include the following steps:
S1101: the RAID management tool sends a logical volume binding command, wherein the parameter is an ID of a logical volume.
S1102: the RIAD controller receives the logical volume binding command, and selects an idle Namespace for binding to the logical volume.
S1103: the RIAD controller reports a change of the Namespace to the host.
S1104: an NVMe driver of the host sends a command to acquire a changed Namespace list.
S1105: the RAID controller reports an identifier of a newly bound Namespace.
S1106: the host starts to perform an IO operation on the newly added namespace, and the binding is completed.

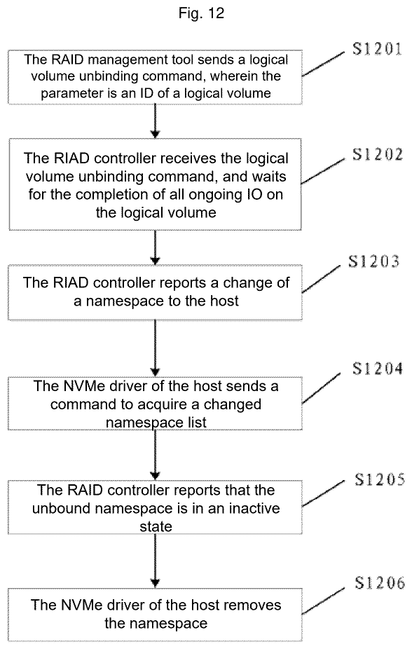

Referring to FIG. 12, FIG. 12 is a flowchart of unbinding a logical volume and a namespace provided in some embodiments of the present disclosure, which may include the following steps:
S1201: the RAID management tool sends a logical volume unbinding command, wherein the parameter is an ID of a logical volume.
S1202: the RIAD controller receives the logical volume unbinding command, and waits for the completion of all ongoing IO on the logical volume.
S1203: the RIAD controller reports a change of a Namespace to the host.
S1204: the NVMe driver of the host sends a command to acquire a changed Namespace list.
S1205: the RAID controller reports that the unbound Namespace is in an inactive state.
S1206: the NVMe driver of the host removes the Namespace.

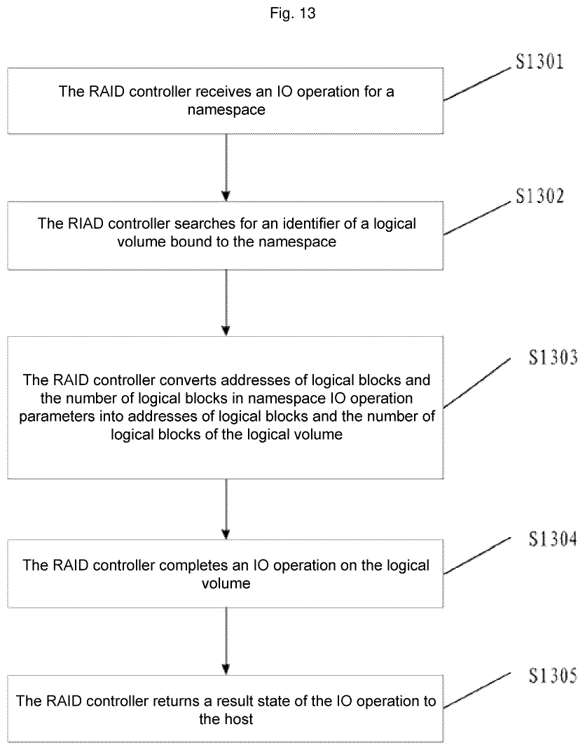

After the logical volume is bound to the Namespace, the host may issue an IO read-write command to the Namespace, wherein the IO read-write command includes a start address of a read-written logical block, and the number of logical blocks. The RAID controller completes an IO request of the host by converting the IO read-write command for the Namespace into the read-write command for the logical volume, the flow is as shown in FIG. 13, and FIG. 13 is a flowchart of converting a Namespace IO operation into a logical volume IO operation provided in some embodiments of the present disclosure, which includes the following steps:
S1301: the RAID controller receives an IO operation for a Namespace.
S1302: the RIAD controller searches for an identifier of a logical volume bound to the Namespace.
S1303: the RAID controller converts addresses of logical blocks and the number of logical blocks in Namespace IO operation parameters into addresses of logical blocks and the number of logical blocks of the logical volume.
S1304: the RAID controller completes an IO operation on the logical volume.
S1305: the RAID controller returns a result state of the IO operation to the host.

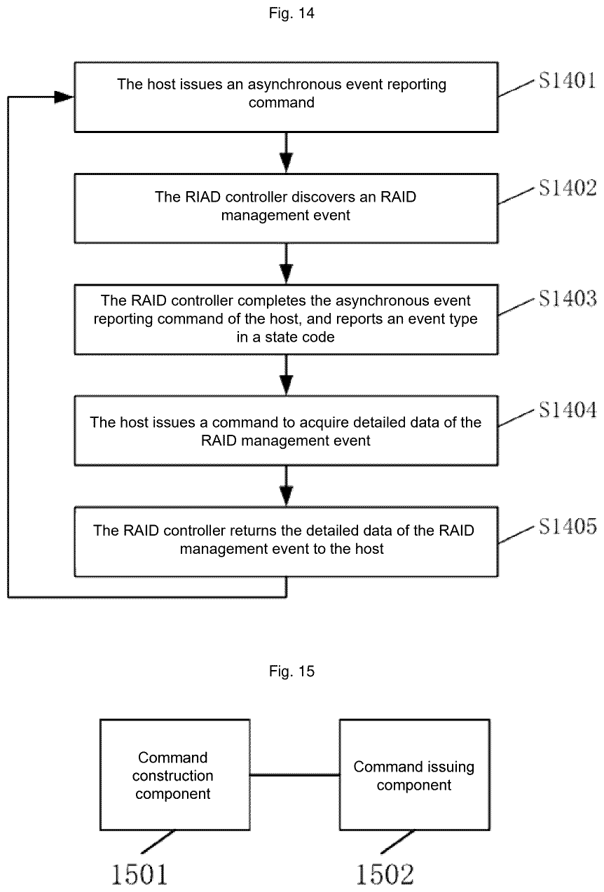

Regarding the method of the RAID group to actively notify the host of an RAID time, when the RAID controller works, the physical disks, the RAID groups and the logical volumes managed by the RAID controller, and the background tasks managed by the RAID controller may have state changes, and related information states need to be reported to the host, referring to FIG. 14, FIG. 14 is an active reporting flowchart of an RAID event provided in some embodiments of the present disclosure, which may include the following steps:
S1401: the host issues an asynchronous event reporting command.
S1402: the RIAD controller discovers an RAID management event.
S1403: the RAID controller completes the asynchronous event reporting command of the host, and reports an event type in a state code.
S1404: the host issues a command to acquire detailed data of the RAID management event.
S1405: the RAID controller returns the detailed data of the RAID management event to the host.

By means of the design and method steps provided in the present embodiment, all commands and flows required for RAID management may be implemented on the standard NVMe interface. Since the NVMe is a standard interface, which has been widely applied to an SSD storage device, and thus has a good host-side driver and management tool; and in combination with the steps in some embodiments of the present disclosure, the RAID management tool on the host may be implemented at a relatively small cost, so that for the development of the RAID controller, the development period related to the host interface may be shortened, the overall development cost is reduced, and the technical difficulty of development is reduced.

Referring to FIG. 15, FIG. 15 is a schematic structural diagram of a system for managing RAID provided in some embodiments of the present disclosure, the system may be applied to a host connected with an RAID controller, the host includes an RAID management tool based on an NVMe interface, and an NVMe device driver, the RAID controller is connected with an RAID, and the system for managing RAID includes:
a command construction component 1501, configured to construct an RAID management command by using the RAID management tool, and encapsulate the RAID management command into an SQE format; and
a command issuing component 1502, configured to write encapsulated RAID management command into an Admin SQ of the RAID controller by using the NVMe device driver, and send notification information to the RAID controller via a doorbell register, so that the RAID controller executes the RAID management command in the Admin SQ after receiving the notification information.

The present embodiment provides a host connected with an RAID controller, wherein the host includes an RAID management tool based on an NVMe interface, and an NVMe device driver, and when a host device needs to manage an RAID connected with the RAID controller, an RAID management command may be constructed by using an RAID management tool, and the RAID management command is encapsulated. The NVMe device driver may write, into an Admin SQ of the RAID controller, the RAID management command encapsulated by the RAID management tool. The RAID controller may read and execute the RAID management command in the Admin SQ. In the above solution, an interface defined by an NVMe standard is used between the RAID controller and the host, and a host side loads an NVMe driver. A command defined by the NVMe between the RAID controller and the host completes a management operation of an RAID. The present solution may implement RAID management on the NVMe interface.

In some embodiments of the present disclosure, the system for managing RAID further includes:
a command completion queue entry acquisition component, configured to read a command completion queue entry in an Admin CQ in response to that the NVMe device driver receives an interrupt notification, and return the command completion queue entry to the RAID management tool, wherein the command completion queue entry is constructed by the RAID controller according to an execution result of the RAID management command.
In some embodiments of the present disclosure, the process of the command construction component 1501 constructing the RAID management command by using the RAID management tool includes: constructing, by using the RAID management tool, the RAID management command including a command operation code, a command parameter and a data pointer, wherein the RAID controller is configured to store data to be returned, which is obtained after the RAID management command is executed, in an address space to which data pointer points.

Embodiments of the present disclosure further provide a system for managing RAID, which is applied to an RAID controller connected with a host, wherein the host includes an RAID management tool based on an NVMe interface, and an NVMe device driver, the RAID controller is connected with an RAID, and the system for managing RAID includes:
a command reading component, configured to: after receiving notification information sent by a doorbell register, read, from an Admin SQ, an RAID management command issued by the host, wherein a process of the host issuing the RAID management command includes: constructing the RAID management command by using the RAID management tool, and encapsulating the RAID management command into an SQE format; and writing encapsulated RAID management command into the Admin SQ of the RAID controller by using the NVMe device driver, and sending the notification information to the RAID controller via the doorbell register; and
a command execution component, configured to execute an operation corresponding to the RAID management command.

The embodiments of the present disclosure provide an RAID controller connected with a host, wherein the host includes an RAID management tool based on an NVMe interface, and an NVMe device driver, and when a host device needs to manage an RAID connected with the RAID controller, an RAID management command may be constructed by using an RAID management tool, and the RAID management command is encapsulated. The NVMe device driver may write, into an Admin SQ of the RAID controller, the RAID management command encapsulated by the RAID management tool. The RAID controller may read and execute the RAID management command in the Admin SQ. In the above solution, an interface defined by an NVMe standard is used between the RAID controller and the host, and a host side loads an NVMe driver. A command defined by the NVMe between the RAID controller and the host completes a management operation of an RAID. The present solution may implement RAID management on the NVMe interface.

In some embodiments of the present disclosure, the system for managing RAID further includes:
a reporting component, configured to: after executing the operation corresponding to the RAID management command on the RAID, construct a command completion queue entry according to an execution result of the RAID management command; and write the command completion queue entry into the Admin CQ of the host, and send an interrupt notification to the NVMe device driver, so that the NVMe device driver reads the command completion queue entry in the Admin CQ and returns the command completion queue entry to the RAID management tool.

In some embodiments of the present disclosure, in response to that the RAID management command is an RAID controller discovery command, the process of the command execution component executing the operation corresponding to the RAID management command includes: parsing the RAID controller discovery command to obtain a first data pointer; and summarizing characteristic data of the RAID controller, and returning the characteristic data of the RAID controller to an address space to which the first data pointer points, wherein the characteristic data of the RAID controller includes any one or a combination of any more of a ready state, a firmware version number, a serial number, a supported RAID level list, a physical disk number list supported by each RAID level, a supported RAID data arrangement mode list, a supported RAID level migration type list, a supported physical disk type list, supported data Cache characteristics, a supported power down protection feature, and state of a standby power supply; and the data Cache characteristics include a Cache capacity and/or a Cache policy type.

In some embodiments of the present disclosure, in response to that the RAID management command is a physical disk discovery command, the process of the command execution component executing the operation corresponding to the RAID management command includes: parsing the physical disk discovery command to obtain a second data pointer; acquiring a physical disk list data structure of all physical disks in the RAID, and returning the physical disk list data structure to an address space to which the second data pointer points, wherein the physical disk list data structure includes an identifier of each physical disk; or, determining a target physical disk corresponding to the physical disk discovery command, and returning physical disk information of the target physical disk to the address space to which the second data pointer points, wherein the physical disk information includes any one or a combination of any more of the identifier of the target physical disk, state of the physical disk, type of the physical disk, size of a logical block supported by the physical disk, capacity of the physical disk, and topological information of the physical disk.

In some embodiments of the present disclosure, in response to that the RAID management command is an RAID group discovery command, the process of the command execution component executing the operation corresponding to the RAID management command includes: parsing the RAID group discovery command to obtain a third data pointer; acquiring an RAID group list data structure of all RAID groups in the RAID, and returning the RAID group list data structure to an address space to which the third data pointer points, wherein the RAID group list data structure includes an identifier of each RAID group; or, determining a target RAID group corresponding to the RAID group discovery command, and returning RAID group information of the target RAID group to the address space to which the third data pointer points, wherein the RAID group information includes any one or a combination of any more of the identifier of the target RAID group, the state of the RAID group, the level of the RAID group, the size of a logical block supported by the RAID group, the capacity of the RAID group, Cache attributes of the RAID group, the state and progress of a background task of the RAID group, and a physical disk list and state of the RAID group.

In some embodiments of the present disclosure, in response to that the RAID management command is a logical volume discovery command, the process of the command execution component executing the operation corresponding to the RAID management command includes: parsing the logical volume discovery command to obtain a fourth data pointer and an identifier of an RAID group to be queried; and according to the identifier of the RAID group to be queried, returning logical volume information of the RAID group to be queried to an address space to which the fourth data pointer points, wherein the logical volume information includes any one or a combination of any more of an identifier of a logical volume, the capacity of the logical volume, the state of the logical volume, and an identifier of an NVM namespace bound to the logical volume.

In some embodiments of the present disclosure, in response to that the RAID management command is a logical volume binding command, the process of the command execution component executing the operation corresponding to the RAID management command includes: parsing the logical volume binding command to obtain an ID of a logical volume to be bound; determining a first namespace which is idle, and sending a namespace binding notification to the host, so that the host sends a to-be-bound namespace query command, wherein the to-be-bound namespace query command is used for acquiring an identifier of a namespace to be bound; and in response to receiving the to-be-bound namespace query command, uploading an identifier of the first namespace to the host, so that the host binds the identifier of the first namespace to the ID of the logical volume to be bound.

In some embodiments of the present disclosure, in response to that the RAID management command is a logical volume unbinding command, the process of the command execution component executing the operation corresponding to the RAID management command includes: parsing the logical volume unbinding command to obtain an ID of a logical volume to be unbound; judging whether all ongoing IO operations on a logical volume corresponding to the ID of the logical volume to be unbound have been executed; in a case where it is judged that all ongoing IO operations on the logical volume corresponding to the ID of the logical volume to be unbound have been executed, sending a namespace unbinding notification to the host, so that the host sends a to-be-unbound namespace query command, wherein the to-be-unbound namespace query command is used for acquiring an identifier of a namespace to be unbound; and in response to receiving the to-be-unbound namespace query command, uploading an identifier of a second namespace to the host, so that the host unbinds the identifier of the second namespace and the ID of the logical volume to be unbound, wherein the second namespace is a namespace bound to the logical volume corresponding to the ID of the logical volume to be unbound.

In some embodiments of the present disclosure, in response to that the RAID management command is a namespace IO read-write command, the process of the command execution component executing the operation corresponding to the RAID management command includes: determining a target namespace corresponding to the namespace IO read-write command, and determining a target logical volume bound to the target namespace; converting an operation parameter of the target namespace in the namespace IO read-write command into an operation parameter of the target logical volume, wherein the operation parameter includes addresses of logical blocks and number of logical blocks; and executing an IO read-write operation on the target logical volume according to the operation parameter of the target logical volume.

In some embodiments of the present disclosure, in response to that the RAID management command is an asynchronous event reporting command, the process of the command execution component executing the operation corresponding to the RAID management command includes:
detecting an RAID management event, and determining an event type corresponding to the RAID management event; and reporting, to the host, a state code corresponding to the event type, so that the host acquires related data of the RAID management event from the RAID controller.

Since the embodiments of the system correspond to the embodiments of the method, reference may be made to the description of the embodiments of the method for the embodiments of the system, and thus details are not repeated herein temporarily.

Embodiments of the present disclosure further provide a non-transitory readable storage medium, storing a computer program thereon, wherein the computer program, when executed, may implement the steps provided in the above embodiments. The non-transitory readable storage medium may include any medium capable of storing program codes, such as a USB flash disk, a mobile hard disk, a read-only memory (ROM), a random access memory (RAM), a magnetic disk, or an optical disk.

Embodiments of the present disclosure further provide an electronic device, including a memory and a processor, wherein a computer program is stored in the memory, and when the processor calls the computer program in the memory, the steps provided in the above embodiments may be implemented. Of course, the electronic device may further include components such as various network interfaces and power supplies.

The embodiments in the specification are described in a progressive manner, and what is highlighted in each embodiment is difference with other embodiments, and the identical or similar parts between the embodiments refer to each other. The system embodiments basically correspond to the method disclosed in the embodiments, and thus are described simply, and reference may be made to the description of the method for related parts. It should be noted that, for those ordinary skilled in the art, several improvements and modifications may also be made to the embodiments of the present disclosure without departing from the principles of the embodiments of the present disclosure, and these improvements and modifications also fall within the protection scope of the claims of the present disclosure.

It should also be noted that, in the present specification, relational terms, such as first and second, are merely used for distinguishing one entity or operation from another entity or operation, and do not necessarily require or imply that any such actual relationship or order exists between these entities or operations. Moreover, the terms “include”, “contain” or any other variants thereof are intended to cover non-exclusive inclusions, such that a process, a method, an article or a device including a series of elements not only includes those elements, but also includes other elements that are not explicitly listed, or also includes elements inherent to such a process, method, article or device. In response to that there are no more restrictions, the element defined by the sentence “including a . . . ” does not exclude the existence of other identical elements in the process, the method, the article or the device that includes the element.

1. A method for managing Redundant Array of Independent Disk (RAID), which is applied to a host connected with an RAID controller, wherein the host comprises an RAID management tool based on a Non-Volatile Memory Express (NVMe) interface, and an NVMe device driver, the RAID controller is connected with an RAID, and the method for managing RAID comprises:
constructing an RAID management command by using the RAID management tool, and encapsulating the RAID management command into a Submission Queue Entry (SQE) format; and
writing encapsulated RAID management command into an Admin Submission Queue (SQ) of the RAID controller by using the NVMe device driver, and sending notification information to the RAID controller via a doorbell register, so that the RAID controller executes the RAID management command in the Admin SQ after receiving the notification information.

2. The method for managing RAID as claimed in claim 1, further comprising:
in response to that the NVMe device driver receives an interrupt notification, reading a command completion queue entry in an Admin Completion Queue (CQ), and returning the command completion queue entry to the RAID management tool,
wherein the command completion queue entry is constructed by the RAID controller according to an execution result of the RAID management command.

3. The method for managing RAID as claimed in claim 1, wherein constructing the RAID management command by using the RAID management tool comprises:
constructing, by using the RAID management tool, the RAID management command comprising a command operation code, a command parameter and a data pointer,
wherein the RAID controller is used for storing data to be returned, which is obtained after the RAID management command is executed, in an address space to which the data pointer points.

4. A method for managing Redundant Array of Independent Disk (RAID), which is applied to an RAID controller connected with a host, wherein the host comprises an RAID management tool based on a Non-Volatile Memory Express (NVMe) interface, and an NVMe device driver, the RAID controller is connected with an RAID, and the method for managing RAID comprises:
after receiving notification information sent by a doorbell register, reading, from an Admin Submission Queue (SQ), an RAID management command issued by the host, wherein a process of the host issuing the RAID management command comprises: constructing the RAID management command by using the RAID management tool, and encapsulating the RAID management command into a Submission Queue Entry (SQE) format; and writing encapsulated RAID management command into the Admin SQ of the RAID controller by using the NVMe device driver, and sending the notification information to the RAID controller via the doorbell register; and
executing an operation corresponding to the RAID management command.

5. The method for managing RAID as claimed in claim 4, wherein after executing the operation corresponding to the RAID management command on the RAID, the method further comprises:
constructing a command completion queue entry according to an execution result of the RAID management command; and
writing the command completion queue entry into an Admin Completion Queue (CQ) of the host, and sending an interrupt notification to the NVMe device driver, so that the NVMe device driver reads the command completion queue entry in the Admin CQ and returns the command completion queue entry to the RAID management tool.

6. The method for managing RAID as claimed in claim 4, wherein in the RAID management command comprises: an RAID controller discovery command; executing the operation corresponding to the RAID management command comprises:
parsing the RAID controller discovery command to obtain a first data pointer; and
summarizing characteristic data of the RAID controller, and returning the characteristic data of the RAID controller to an address space to which the first data pointer points,
wherein the characteristic data of the RAID controller comprises any one or a combination of any more of a ready state, a firmware version number, a serial number, a supported RAID level list, a physical disk number list supported by each RAID level, a supported RAID data arrangement mode list, a supported RAID level migration type list, a supported physical disk type list, supported data Cache characteristics, a supported power down protection feature, and a state of a standby power supply; and the data Cache characteristics comprise at least one of the following: a Cache capacity and/or a Cache policy type.

7. The method for managing RAID as claimed in claim 4, wherein the RAID management command comprises: a physical disk discovery command; executing the operation corresponding to the RAID management command comprises:
parsing the physical disk discovery command to obtain a second data pointer;
acquiring a physical disk list data structure of all physical disks in the RAID, and returning the physical disk list data structure to an address space to which the second data pointer points, wherein the physical disk list data structure comprises an identifier of each physical disk;
or, determining a target physical disk corresponding to the physical disk discovery command, and returning physical disk information of the target physical disk to the address space to which the second data pointer points, wherein the physical disk information comprises any one or a combination of any more of an identifier of the target physical disk, a state of the physical disk, a type of the physical disk, a size of a logical block supported by the physical disk, a capacity of the physical disk, and topological information of the physical disk.

8. The method for managing RAID as claimed in claim 4, wherein the RAID management command comprises: an RAID group discovery command; executing the operation corresponding to the RAID management command comprises:
parsing the RAID group discovery command to obtain a third data pointer;
acquiring an RAID group list data structure of all RAID groups in the RAID, and returning the RAID group list data structure to an address space to which the third data pointer points, wherein the RAID group list data structure comprises an identifier of each RAID group;
or, determining a target RAID group corresponding to the RAID group discovery command, and returning RAID group information of the target RAID group to the address space to which the third data pointer points, wherein the RAID group information comprises any one or a combination of any more of an identifier of the target RAID group, a state of the RAID group, a level of the RAID group, a size of a logical block supported by the RAID group, a capacity of the RAID group, Cache attributes of the RAID group, a state and progress of a background task of the RAID group, and a physical disk list and state of the RAID group.

9. The method for managing RAID as claimed in claim 4, wherein the RAID management command comprises: a logical volume discovery command; executing the operation corresponding to the RAID management command comprises:
parsing the logical volume discovery command to obtain a fourth data pointer and an identifier of an RAID group to be queried; and
according to the identifier of the RAID group to be queried, returning logical volume information of the RAID group to be queried to an address space to which the fourth data pointer points,
wherein the logical volume information comprises any one or a combination of any more of an identifier of a logical volume, a capacity of the logical volume, a state of the logical volume, and an identifier of an NVM namespace bound to the logical volume.

10. The method for managing RAID as claimed in claim 4, wherein the RAID management command comprises: a logical volume binding command; executing the operation corresponding to the RAID management command comprises:
parsing the logical volume binding command to obtain an ID of a logical volume to be bound;
determining a first namespace which is idle, and sending a namespace binding notification to the host, so that the host sends a to-be-bound namespace query command, wherein the to-be-bound namespace query command is used for acquiring an identifier of a namespace to be bound; and
in response to receiving the to-be-bound namespace query command, uploading an identifier of the first namespace to the host, so that the host binds the identifier of the first namespace to the ID of the logical volume to be bound.

11. The method for managing RAID as claimed in claim 4, wherein the RAID management command comprises: a logical volume unbinding command; executing the operation corresponding to the RAID management command comprises:
parsing the logical volume unbinding command to obtain an ID of a logical volume to be unbound;
judging whether all ongoing IO operations on a logical volume corresponding to the ID of the logical volume to be unbound have been executed;
in a case where it is judged that all ongoing IO operations on the logical volume corresponding to the ID of the logical volume to be unbound have been executed, sending a namespace unbinding notification to the host, so that the host sends a to-be-unbound namespace query command, wherein the to-be-unbound namespace query command is used for acquiring an identifier of a namespace to be unbound; and
in response to receiving the to-be-unbound namespace query command, uploading an identifier of a second namespace to the host, so that the host unbinds the identifier of the second namespace and the ID of the logical volume to be unbound, wherein the second namespace is a namespace bound to the logical volume corresponding to the ID of the logical volume to be unbound.

12. The method for managing RAID as claimed in claim 4, wherein the RAID management command comprises: a namespace IO read-write command; executing the operation corresponding to the RAID management command comprises:
determining a target namespace corresponding to the namespace IO read-write command, and determining a target logical volume bound to the target namespace;
converting an operation parameter of the target namespace in the namespace IO read-write command into an operation parameter of the target logical volume, wherein the operation parameter comprises addresses of logical blocks and a number of logical blocks; and
executing an IO read-write operation on the target logical volume according to the operation parameter of the target logical volume.

13. The method for managing RAID as claimed in claim 4, wherein the RAID management command comprises: an asynchronous event reporting command; executing the operation corresponding to the RAID management command comprises:
detecting an RAID management event, and determining an event type corresponding to the RAID management event; and
reporting, to the host, a state code corresponding to the event type, so that the host acquires related data of the RAID management event from the RAID controller.

14. The method for managing RAID as claimed in claim 4, wherein the RAID management command comprises a discovery class command, a disk management class command, and a task management class command.

15. The method for managing RAID as claimed in claim 14, wherein the discovery class command comprises an RAID controller discovery command, a physical disk discovery command, an RAID group discovery command, and a logical volume discovery command; the disk management class command comprises an RAID group creation and deletion command, a logical volume creation and deletion command, and a command for binding and unbinding a logical volume and a namespace; and the task management class command comprises a start and stop command of a background task, and a parameter configuration command.

16. The method for managing RAID as claimed in claim 5, wherein the Admin CQ is used for an NVMe controller to report command completion to the host, each command completion queue entry in the Admin CQ corresponds to a command completion data structure reported by one NVMe controller.

17.-18. (canceled)

19. An electronic device, comprising a memory and a processor, wherein a computer program is stored in the memory, and the processor, when calling the computer program in the memory, is configured to:
construct a Redundant Array of Independent Disk (RAID) management command by using an RAID management tool, and encapsulate the RAID management command into a Submission Queue Entry (SQE) format; and
write encapsulated RAID management command into an Admin Submission Queue (SQ) of an RAID controller by using a Non-Volatile Memory Express (NVMe) device driver, and send notification information to the RAID controller via a doorbell register, so that the RAID controller executes the RAID management command in the Admin SQ after receiving the notification information.

20. (canceled)

21. The method for managing RAID as claimed in claim 1, wherein the host send the NVMe RAID management command to the RAID controller via an NVMe host interface.

22. The method for managing RAID as claimed in claim 4, wherein the host send the NVMe RAID management command to the RAID controller via an NVMe host interface.

23. The electronic device as claimed in claim 19, wherein the processor is further configured to:
in response to that the NVMe device driver receives an interrupt notification, read a command completion queue entry in an Admin Completion Queue (CQ), and return the command completion queue entry to the RAID management tool,
wherein the command completion queue entry is constructed by the RAID controller according to an execution result of the RAID management command.
